(19) United States
(12) Patent Application Publication
(10) Pub. No.: US 2026/0004643 A1
(43) Pub. Date: Jan. 1, 2026

(54) ELECTRONIC GAMING SYSTEM AND METHOD HAVING MULTIPLE SUB-METAMORPHIC FEATURES

(71) Applicant: Aristocrat Technologies, Inc., Las Vegas, NV (US)

(72) Inventors: Daniel Marks, Decatur, GA (US); Hua Xu, Marietta, GA (US)

(21) Appl. No.: 19/244,862

(22) Filed: Jun. 20, 2025

Related U.S. Application Data
(60) Provisional application No. 63/665,756, filed on Jun. 28, 2024.

(51) Int. Cl. G07F 17/32

(52) U.S. Cl. CPC G07F 17/3267; G07F 17/3211

(57) ABSTRACT

A gaming system includes a processor configured to cause display of a game outcome in a primary display area of at least one display, cause display of a metamorphic indicator in a secondary display area of the at least one display, and cause display of a plurality of sub-metamorphic indicators in visual association with the metamorphic indicator. The visual association links the plurality of sub-metamorphic indicators with the metamorphic indicator. Each sub-metamorphic indicator of the plurality of sub-metamorphic indicators has a reduced size relative to the metamorphic indicator, and identifies a respective feature enhancement awardable in response to a metamorphic trigger symbol occurring in the game outcome. In response to the metamorphic trigger symbol occurring in the game outcome, the processor determines whether to award a feature enhancement associated with at least one of the plurality of sub-metamorphic indicators.

### CROSS-REFERENCE TO RELATED APPLICATIONS

This application claims priority to U.S. Patent Application No. 63/665,756, filed Jun. 28, 2024, the contents of which are incorporated by reference herein in its entirety.

### TECHNICAL FIELD

The field of disclosure relates generally to electronic gaming devices, and more particularly to electronic gaming systems and methods that provide multiple, dynamically selectable metamorphic features and sub-metamorphic features during game play.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming system includes at least one processor and at least one memory storing instructions thereon. The instructions, when executed by the at least one processor, cause the at least one processor to cause display of a game outcome in a primary display area of at least one display and cause display of a metamorphic indicator in a secondary display area of the at least one display. The instructions further cause the at least one processor to cause display of a plurality of sub-metamorphic indicators in visual association with the metamorphic indicator in the secondary display area. The visual association links the plurality of sub-metamorphic indicators with the metamorphic indicator. Each sub-metamorphic indicator of the plurality of sub-metamorphic indicators has a reduced size on the at least one display relative to the metamorphic indicator and identifies a respective feature enhancement that is awardable based on a triggering of the metamorphic indicator. The instructions further cause the at least one processor to identify a metamorphic trigger symbol occurring in the game outcome, the metamorphic trigger symbol being a trigger for the metamorphic indicator and determine, in response to identifying the metamorphic trigger symbol, whether to award a feature enhancement associated with at least one of the plurality of sub-metamorphic indicators.

In another aspect, a non-transitory computer-readable medium storing instructions thereon is provided. When executed by at least one processor the instructions cause the at least one processor to cause display of a game outcome in a primary display area of a display, the game outcome including a metamorphic trigger symbol and cause display of a metamorphic indicator in a secondary display area of the display, wherein the metamorphic trigger symbol is a trigger for the metamorphic indicator. The instructions further cause display of a plurality of sub-metamorphic indicators in the secondary display area, each sub-metamorphic indicator of the plurality of sub-metamorphic indicators being displayed in position adjacent to or along the metamorphic indicator, having a reduced size on the display relative to the metamorphic indicator, and identifying a respective feature enhancement that is awardable based on a triggering of the metamorphic indicator. The instructions further cause the at least one processor to determine, based on the game outcome including the metamorphic trigger symbol, whether to award a feature enhancement associated with at least one of the plurality of sub-metamorphic indicators.

In yet another aspect, a method of electronic gaming is provided. The method includes displaying a game outcome in a primary display area of at least one display, displaying a metamorphic indicator in a secondary display area of the at least one display, and displaying a plurality of sub-metamorphic indicators in visual association with the metamorphic indicator in the secondary display area. The visual association links the plurality of sub-metamorphic indicators with the metamorphic indicator. Each sub-metamorphic indicator of the plurality of sub-metamorphic indicators has a reduced size on the at least one display relative to the metamorphic indicator and identifies a respective feature enhancement that is awardable based on a triggering of the metamorphic indicator. The method further includes identifying, by at least one processor, a metamorphic trigger symbol occurring in the game outcome, the metamorphic trigger symbol being a trigger for the metamorphic indicator and determining, by the at least one processor, in response to identifying the metamorphic trigger symbol, whether to award a feature enhancement associated with at least one of the plurality of sub-metamorphic indicators.

### BRIEF DESCRIPTION OF THE DRAWINGS

FIG. 1 is an exemplary diagram showing several gaming machines networked with various gaming related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flow chart of a process for executing electronic game play for display to a user.

FIG. 5 is an example screen display showing display of a game according to the process of FIG. 4, prior to initiating a first game instance.

FIG. 6 is an example screen display showing display of the first game instance of the game shown in FIG. 5.

FIG. 7 is another example screen display showing display of the first game instance of the game shown in FIG. 5.

FIG. 8 is an example screen display, showing a second game instance of the game shown in FIG. 5.

FIG. 9 is another example screen display, showing the second game instance of the game shown in FIG. 5.

FIG. 10 is an example screen display showing display of an alternative game according to the process of FIG. 4, prior to initiating a first game instance.

FIG. 11 is an example screen display showing display of the first game instance of the game shown in FIG. 10.

FIG. 12 is an example screen display showing display of a first feature game instance of the game shown in FIG. 10.

### DETAILED DESCRIPTION

The disclosure generally describes improving the user-interface (“UI”) efficiency by efficiently displaying a relatively larger number of metamorphics game features. Specifically, a game can include one or more sub-metamorphics that are associated with a single metamorphic. When a game triggers a single metamorphic, the game may trigger one or more of the sub-metamorphics associated with the metamorphic.

Some games involve display of what is sometimes referred to as a “metamorphic,” a “game metamorphic,” a “metamorphic image,” a “metamorphic meter,” etc., (referred to herein as a “metamorphic”) which change or metamorphose over time in response to gaming events. In one implementation, one or more metamorphics are displayed in a display area separate from a symbol array and are displayed to visibly change overtime during gameplay, such as, for example but not limited to, in a size, shape, position, effect, and/or color. Generally, current games typically have 1-3 metamorphic features in a game, where each metamorphic feature can trigger a corresponding bonus feature. In one implementation, the metamorphic features can be symbol driven such that when a trigger symbol (e.g., green symbol) lands in the symbol matrix, the game generates an output of a random number generator (“RNG”) to determine whether to trigger the metamorphic feature (e.g., green colored metamorphic feature) linked to the trigger symbol. Because of the popularity of the metamorphic features, games in the future could start to include more than three metamorphic features. However, as the number metamorphic features increase, presenting the metamorphic features in easy to decipher/efficient manner becomes more difficult. Specifically, a gaming device may have a display device with a display size that may not be able to fit or accommodate the desired number of metamorphic features. For example, a game shown on a mobile device could not practically present or display 12-15 different metamorphic features to a player. Thus, a better method is needed to display more metamorphic features within a game display.

For purposes of this disclosure, the term “symbol driven” within this disclosure refers to where landing one or more trigger symbols in a reel grid determine a specific game outcome and/or whether to randomly trigger one or more game features (e.g., metamorphic feature). The landing of the trigger symbols is randomly generated from one or more RNG outputs that establish one or more stop positions for one or more reel strips. Additionally, or alternatively, one or more game outcomes and/or game features (e.g., metamorphic feature) in a game could be “randomly driven.” Randomly driven refers to RNG outputs that are either independent from the symbol driven game outcome or in lieu of the symbol driven game outcome. For example, a game can randomly drive whether to trigger a metamorphic feature by performing one or more RNG outputs that are separate and independent from the RNG outputs used for identifying the stop positions of reel strips shown in a reel matrix. In another example, the game could generate RNG outputs to randomly drive a pre-determined game outcome rather than randomly determining stop positions for reel strips. In such randomly driven, pre-determined game outcomes, a game may use a presentation engine to determine how to present the pre-determined game outcomes on a gaming device.

Embodiments of the disclosure provide a technical solution of efficiently displaying a relatively larger number of metamorphic features on a game display device. Specifically, the game presents sub-metamorphics that can trigger in response to triggering the main metamorphic feature. As an example, a game could include N number of main metamorphic features (e.g., three) where each main metamorphic feature includes M number of sub-metamorphics. In other words, each main metamorphic features could have a number of levels (e.g., four levels). The different sub-metamorphics could be cumulative and/or work together for a single game feature or the sub-metamorphics could be different and not work together in building out a single game feature. Each time one of the main metamorphic feature triggers, one or more of the sub-metamorphics associated with the triggered main metamorphic feature could also trigger.

In one embodiment, there are three metamorphic features represented as three strands of fireworks. To incorporate sub-metamorphics, there could be three different emblems positioned on top of each fireworks strand. Each emblem would represent a sub-metamorphic that is linked to one of the main metamorphics feature. When the first strand of fireworks (e.g., purple strand) lights up, the game may explode one or more of the emblems sitting on top of the first strand of fireworks. In one embodiment, the sub-metamorphics will be related to the metamorphic feature assigned to the first strand of fireworks. In another embodiment, the sub-metamorphics are different from the main metamorphics.

By having sub-metamorphics, the game can produce multiple outcomes when the game triggers a single metamorphic feature. The outcomes for certain sub-metamorphics could change if the game is in the base game or already in a bonus feature. The sub-metamorphics could also change state when the main metamorphic changes state.

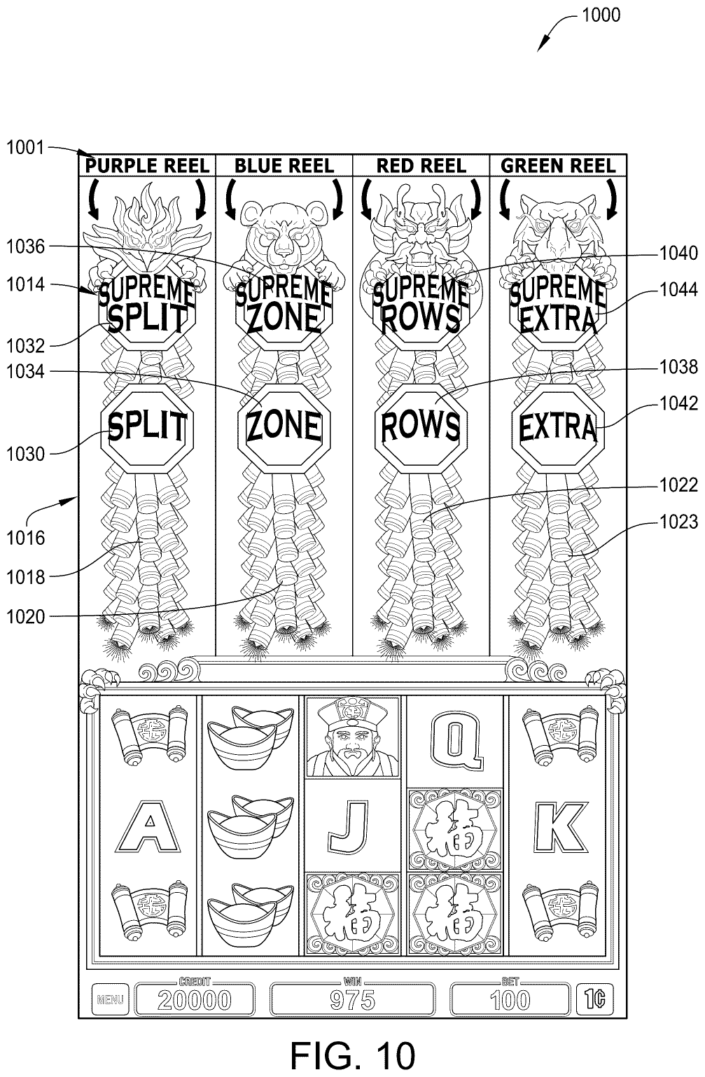

Embodiments of the disclosure include a dynamic selection of metamorphic features using a primary metamorphic indicator (also referred to herein as a metamorphic indicator) that each include a plurality of sub-metamorphics. The dynamic selection may include a single trigger symbol that designates a particular metamorphic and a lookup of a weighted table using an RNG output to determine whether and which of the sub-metamorphics are triggered. As a result, the dynamic selection of sub-metamorphics allows for a large number of feature enhancements to be displayed to a player during gameplay, without overcrowding the display screen. The sub-metamorphics may have a smaller (i.e., reduced) size on the display screen than the associated metamorphic indicators. As a result, embodiments of the present disclosure provide a technical improvement in improved display variance and improved efficiency in the use of screen area of a display, without increasing processing requirements required to display a large number of metamorphic features or select from a large number of metamorphic features. The improvement in efficiency in the use of screen area is compounded by the potential combinations of different feature enhancements associated with each of the metamorphic indicator. In one example described herein, for a game having four metamorphic indicators each having two sub-metamorphic features (e.g., as shown in the embodiment of FIGS. 10-12), there is a potential to display and award 80 different combinations of feature enhancements based on the displayed metamorphic indicators.

Embodiments of the disclosure provide an improved control of award outcomes resulting from a large number of metamorphic features by utilizing different weighted probability tables associated with different triggering symbols in the game outcomes and by performing a dual lookup process to determine features that are triggered based on a trigger symbol occurring in the game outcome. For example, in one embodiment of the disclosure, each of the metamorphic indicators is associated with a color that matches symbols on the reels. In a symbol driven embodiment, after the game outcome is generated, the game outcome is first reviewed to determine how many different color trigger symbols have occurred in the game outcome. If three different color trigger symbols occur in the game outcome a different set of a probability weighted tables may be used relative to if two or less different color symbols occur in the game outcome. The selected tables are then used to determine whether a feature of a metamorphic indicator is awarded and if so, what level of the feature is awarded. In one example, the first lookup is performed to determine whether a multiplier metamorphic is triggered and, if so, a second lookup is performed to determine what level of the multiplier (e.g., 1×, 2×, 4×, etc.) is awarded. Each of the first and second lookups may be performed using the weighted tables selected based on the types of trigger symbols.

The technical problems addressed herein include: (i) inability of known systems to display of a large number (e.g., more than five) metamorphic features in conjunction with a primary game; (ii) inability of known systems to display visual indications of different levels of feature enhancements in association with a metamorphic feature; (iii) inability of known systems to control award outcomes resulting from a large number of metamorphic features; (iv) inability of known systems to provide enhanced display variance for collecting a large number of metamorphic features; (v) inefficient use of computer resources in known gaming systems at least because of burdensome processing requirements when displaying a large number of metamorphic features; and (vi) lack of processing availability and speed in known gaming systems at least because of the burdensome processing requirements.

The resulting technical effect and/or technical benefits achieved herein include at least one of: (i) ability to provide display of a large number metamorphic features in conjunction with a primary game; (ii) ability to display visual indications of different levels of feature enhancements in association with a metamorphic feature; (iii) ability to control award outcomes resulting from a large number of metamorphic features; (iv) ability to provide enhanced display variance for collecting a large number of metamorphic features; (v) improved efficiency in the use of computer resources by displaying sub-metamorphic features in visual association with metamorphic indicators; and (vi) improved processing availability and speed at least because of the improved efficiency in the use of computer resources.

The description provided herein includes certain examples and exemplary use cases. It should be understood that these examples and use cases are included herein for illustrative purposes, and these examples and use cases should not be taken to limit the present disclosure. The systems and methods described herein may be used in many other use cases.

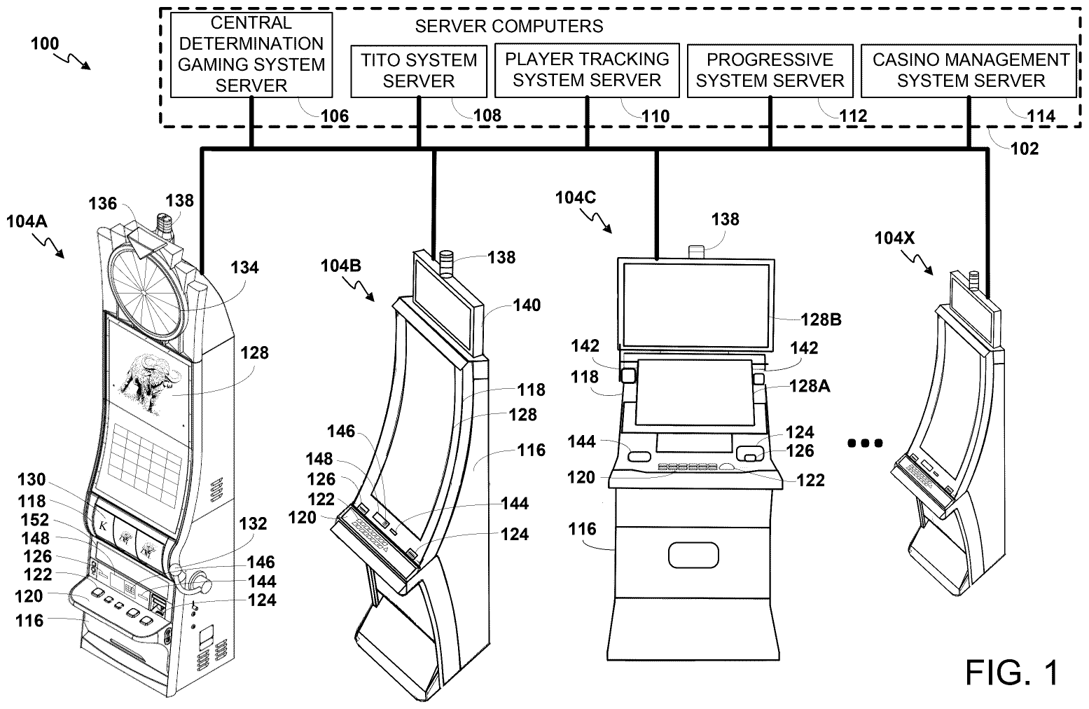

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

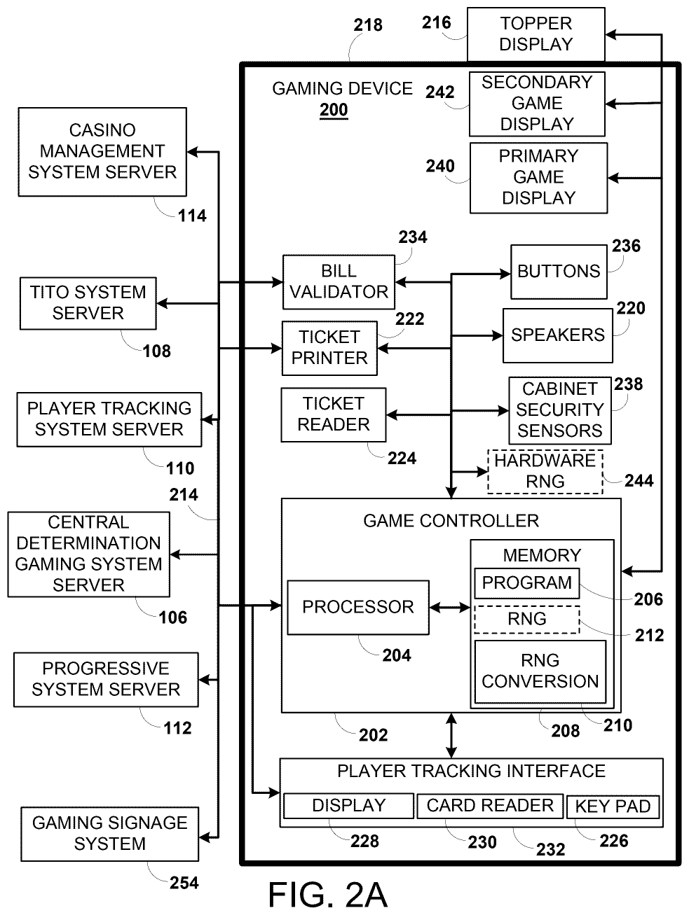

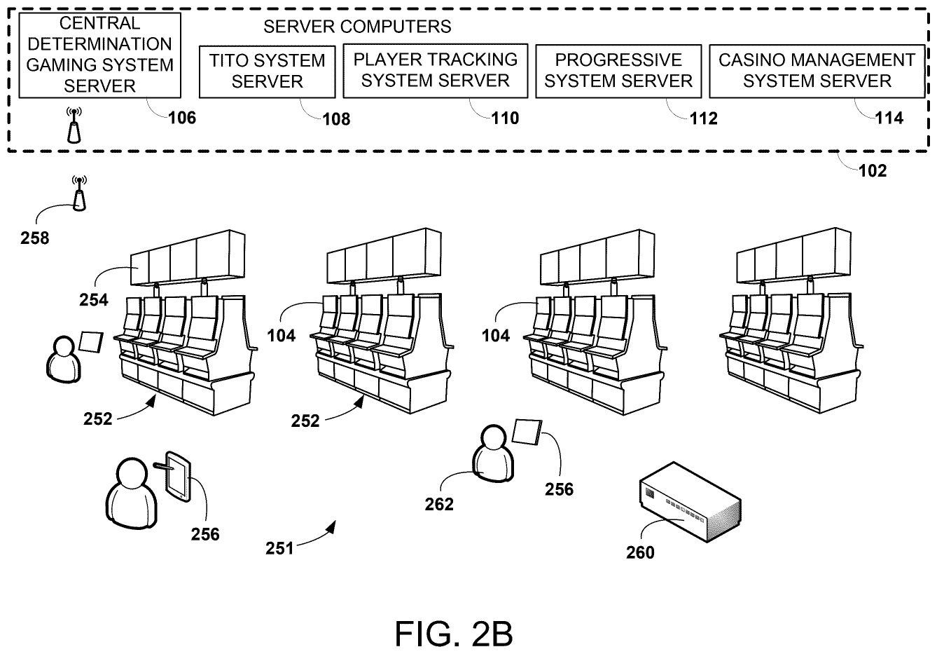

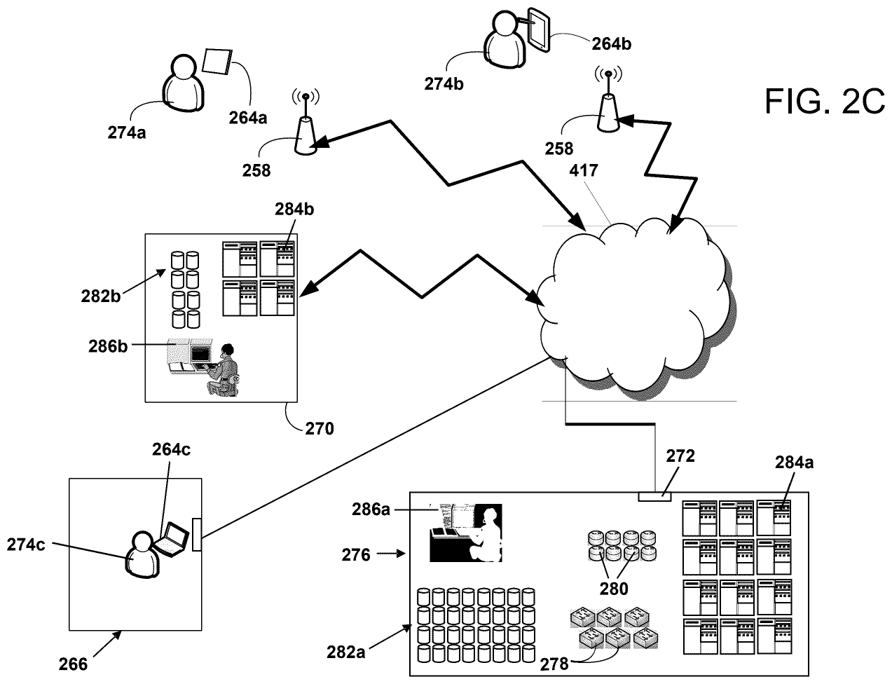

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

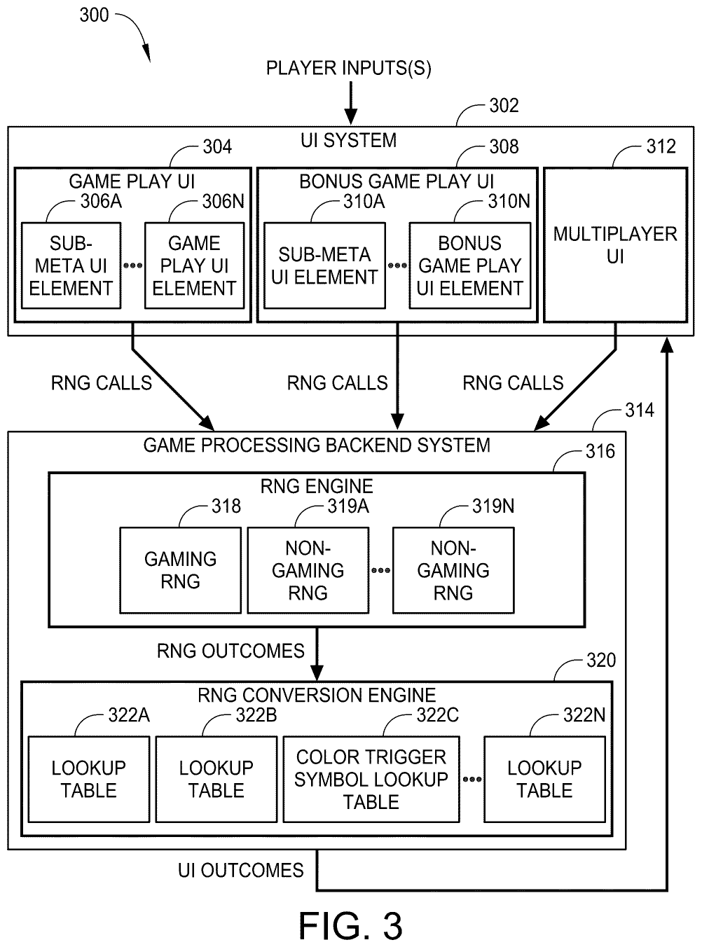

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. The UI elements include sub-metamorphic UI elements 306A that depict one or more sub-metamorphic indicators as described herein. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. The bonus game play UI elements 310A-310N include sub-metamorphic UI elements 310A that depict one or more sub-metamorphic indicators as described herein. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. The lookup tables include one or more color trigger symbol lookup tables 322C that are used to assign metamorphic associations (e.g., colors) to metamorphic trigger symbols that may occur in game outcomes as described below. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

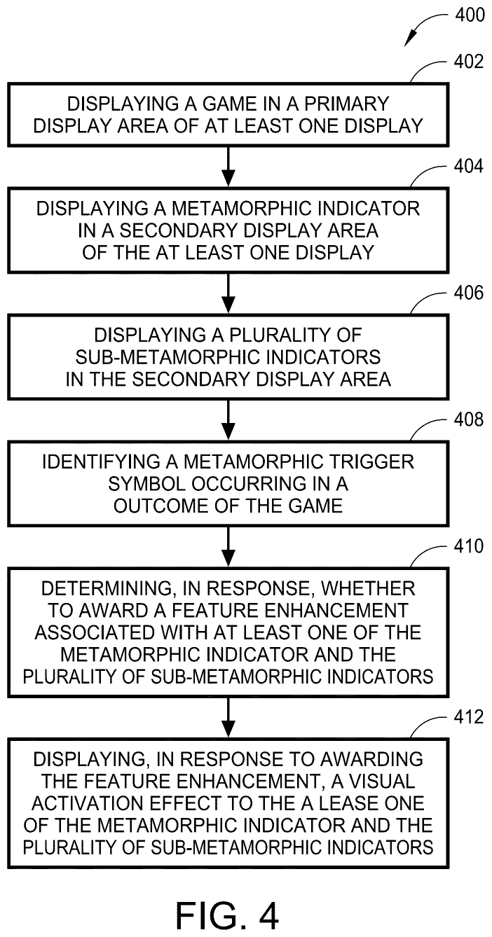

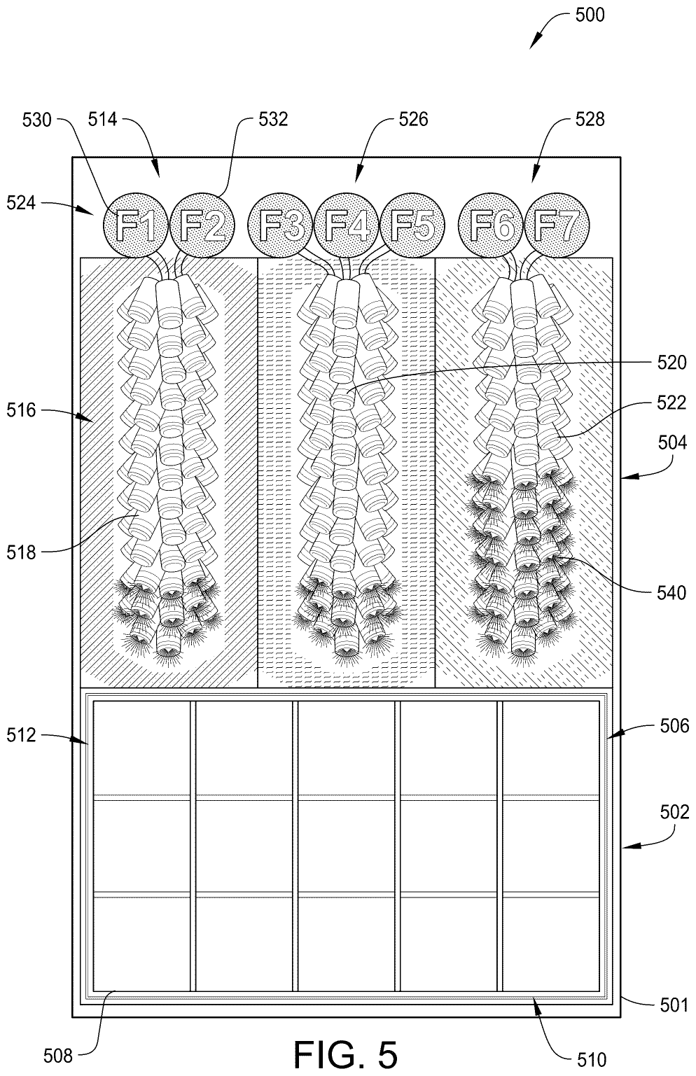

FIG. 4 shows an example process 400 of executing gameplay of the game shown in FIGS. 5-9. FIG. 5 shows a schematic of an example game display 500, which may be displayed on a main display 240 (shown in FIG. 2A) of a gaming device. The gaming device may be similar to gaming devices 104A-104X, shown in FIG. 1 and/or a mobile gaming device 256. The processor 204 configures play of the game based on a set of instructions stored in the memory 208.

As shown in FIG. 4, a first step 402 of the process 400 includes displaying a game in a primary display area of at least one display. Referring to FIG. 5, display 500 of a first play instance of an electronic game on a game display 501 is shown. The display 500 includes a primary game display area 502 and a secondary display area 504 that is spaced from the primary game display area 502. In the example embodiment, the electronic display 501 is a single display screen, though in other embodiments the electronic display 501 may include one or more display screens. For example, in some embodiments the primary game display area 502 is displayed on a first display and the secondary display area 504 is displayed on a second different display.

The primary game display area 502 includes a matrix 506 of symbol positions 508 arranged in a plurality columns 510 and a plurality of rows 512. During play of the game, matrix 506 the symbol positions are each populated with one or more symbols, corresponding to an outcome of the game. In the example embodiment, the game is a base game. Based on outcomes of the base game, a feature game may be initiated in response to one or more feature trigger conditions being satisfied. The feature trigger conditions may be based on a randomized game outcome, such as an output of a random number generator (“RNG”), awarding of one or more feature enhancements, and/or occurrence of a feature trigger symbol in an outcome of the base game.

As shown in FIG. 4, a second step 404 of the process 400 includes displaying a metamorphic indicator in a secondary display area of the at least one display. A third step 406 of the process 400 includes displaying a plurality of sub-metamorphic indicators in the secondary display area.

Referring to FIG. 5, the secondary display area 504 includes a plurality of sub-metamorphic indicators 514 that are each displayed in a visual association with a respective metamorphic indicator 516. The sub-metamorphic indicators 514 identify respective feature enhancements that may be awarded in response to a triggering of their associated metamorphic indicators 516.

In the example embodiment, three metamorphic indicators 518, 520, 522 are each displayed in a visual association with a respective group of sub-metamorphic indicators 524, 526, 528. The visual association may include any displayed linking between the metamorphic indicators 516 and respective sub-metamorphic indicators 516 that conveys a gameplay-based association between the metamorphic indicators 516 and their respective sub-metamorphic indicators 514. The visual association may include a positioning of the sub-metamorphic indicators 514 relative to the metamorphic indicators 516, such as adjacent to, grouped near, and/or connected to the metamorphic indicators 516 as shown in FIGS. 5-9. The visual association may, additionally or alternatively, include a positioning of the sub-metamorphic indicators 514 directly on their respective metamorphic indicators 516 as shown in FIGS. 10-12. Additionally or alternatively, in some embodiments the visual association includes a positioning of the sub-metamorphic indicators in an alignment (e.g., vertical or horizontal) with the metamorphic indicators 516, or in any other suitable manner that conveys a gameplay-based association as described herein. The sub-metamorphic indicators 514 are each displayed to have a size that is reduced relative to the metamorphic indicators 516. As a result, the display configuration of the metamorphic indicators 516 and the sub-metamorphic indicators 514 improve the user-interface (“UI”) efficiency by efficiently displaying a relatively larger number of metamorphics game features.

For example, referring to FIG. 5 a first sub-metamorphic group 524 includes a first sub-metamorphic indicator 530 (“F1”) and a second sub-metamorphic indicator 532 (“F2”), that are each shown in visual association with the first metamorphic indicator 518. Specifically, the first sub-metamorphic indicator 530 and the second sub-metamorphic indicator 532 are each positioned directly above the first metamorphic indicator 518 and are shown as being connected to the first metamorphic indicator 518. A second sub-metamorphic group 526 includes three sub-metamorphic indicators 514 (“F3”, “F4”, and “F5”) in visual association with the second metamorphic indicator 520. A third sub-metamorphic group 528 includes two sub-metamorphic indicators (“F6” and “F7”) in visual association with the third metamorphic indicator 522. In other embodiments, any number of metamorphic indicators 516 may be included and may include any number of associated sub-metamorphic indicators 514. In the example embodiment, the metamorphic indicators 516 are each displayed as a strand of firecrackers that extends longitudinally on the secondary display area 504 and the sub-metamorphic indicators 514 are displayed as circular emblems that are positioned above their respective firecrackers strands. In other embodiments, other suitable designs may be used for any one of the metamorphic indicators 516 and/or sub-metamorphic indicators 514.

In other embodiments, sub-metamorphic indicators 514 may be displayed in other suitable manners to provide a visual association with the respective metamorphic indicators 516. In one embodiment, the first sub-metamorphic indicator 530 and second sub-metamorphic indicator 532 may be each be positioned on the first metamorphic indicator 518 and, optionally, at different positions along the first metamorphic indicator 518. For example, in some such embodiments, the first sub-metamorphic indicator 530 may be displayed at a midpoint along a length of the strand of firecrackers of the first metamorphic indicator 518 and the second sub-metamorphic indicator 532 may be displayed at an end of the strand of firecrackers.

In the example embodiment, each of the metamorphic indicators 516 is associated with a feature enhancement type that may be applied to outcomes of gameplay during play of a feature game and/or base game. Each of the sub-metamorphic indicators 514 of a group 524, 526, 528 are associated with, in that they identify, related feature enhancements of the feature enhancement type associated with the respective metamorphic indicator 516 and may provide a different level or amount of the corresponding feature enhancement type. For example, in the embodiment of FIG. 5, the first metamorphic indicator 518 is associated with a feature enhancement type of increasing a number of rows of matrix 506 during play of the feature game. The first sub-metamorphic indicator 530 corresponds to a feature enhancement of adding one additional row to matrix 506 (referred to herein as “one additional row”), and the second sub-metamorphic indicator 532 corresponds to a feature enhancement of adding two additional rows to matrix 506 (referred to herein as “two additional rows”). Other non-limiting examples of suitable feature enhancements associated with metamorphic indicators 516 and/or sub-metamorphic indicators 514 include awarding one or more additional symbols within symbol positions of matrix (e.g., 2, 3, or 4 symbols in each outcome), a multiplier (e.g., 2×, 3×, 4×, etc.), triggering play of one or more types of free feature games (e.g., a “free plays” feature game, a “Match Three” feature game, a “Pick and Pop” feature game), and adding one or more columns to matrix 506.

In other embodiments, sub-metamorphic indicators 514 of a same group 524, 526, 528 may not correspond to related feature enhancements. For example, in one embodiment the first sub-metamorphic indicator 530 of the first group 524 corresponds to the “one additional row” feature enhancement, and the second sub-metamorphic indicator 532 corresponds to an unrelated feature enhancement, such as extra WILD symbols, a multiplier, or any other suitable feature enhancement described herein.

The metamorphic indicators 516 are each displayed with a visible identifier that differentiates the metamorphic indicators 516 from one another. In the example embodiment, the visible identifier is a distinguishing color. The first metamorphic indicator 518 is displayed in a red color, the second metamorphic indicator 520 is displayed in a green color, and the third metamorphic indicator 522 is displayed in blue color. In the black and white drawings of FIGS. 5-9, different hatching types are used to convey the different colors of the metamorphic indicators 518, 520, 522. Other non-limiting suitable visible identifiers for metamorphic indicators 516 may include a text label, a shape type, and a pictorial representation.

Metamorphic indicators 516 are each configured to be changed during successive play instances of base game, to provide a visual indication of progress relative to the feature enhancements associated with the metamorphic indicator 516 and or the respective sub-metamorphic indicators 514. In particular, in the example embodiment, as described in greater detail below, metamorphic indicators 516 are changed by a visual incrementing effect 540, the progression of which is associated with the occurrence of metamorphic trigger symbols 602 in the game outcome that have not resulted in awarding of a feature enhancement. In the example embodiment, the metamorphic indicators 516 are changed by illuminating and/or igniting portions of the firecrackers.

As shown in FIG. 4, a fourth step 408 in the process 400 includes identifying a metamorphic trigger symbol occurring in an outcome of the base game.

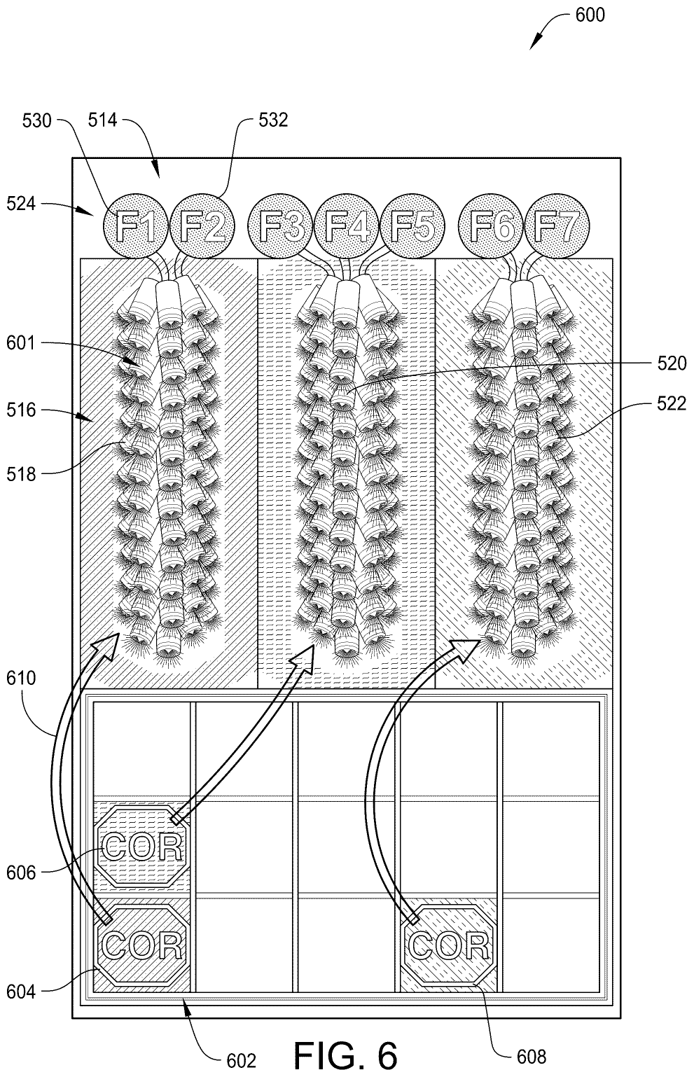

FIG. 6 shows a display 600 of a first game instance. In the example of FIG. 6, three metamorphic trigger symbols 602 are shown in an outcome of the base game. The metamorphic trigger symbols 602 include a first trigger symbol 604, associated with the first metamorphic indicator 518, a second trigger symbol 606, associated with the second metamorphic indicator 520, and a third trigger symbol 608, associated with the third metamorphic indicator 522. Each of the trigger symbols 602 is displayed with a visual indicator that identifies to a player which metamorphic indicator 518, 520, 522 the respective trigger symbol 602 is associated with. For example, the first trigger symbol 604, second trigger symbol 606, and third trigger symbol 608, are displayed with a color corresponding to the colors of the metamorphic indicators 518, 520, 522 (e.g., red, green, and blue, respectively). As shown in the black and white drawing of FIG. 6, the hatching of symbols 604, 606, and 608 each match, respectively, the hatchings of metamorphic indicators 518, 520, and 522, to illustrate a corresponding colors of the symbols 604, 606, 608 matching the colors of the metamorphic indicators 518, 520, 522. In other embodiments, any suitable visual indicator for trigger symbols 602 may be used, such as a label, shape, pictorial representation, etc.

In the example embodiment, each of the trigger symbols 602 is a cash-on-reel (“COR”) symbol that includes a credit value awarded to the player if a winning outcome occurs. In the example embodiment, credit values displayed on the COR symbol are determined dynamically prior to each spin. In other embodiments, the credit values may be fixed with the COR symbols on the reels. In yet other embodiments, the trigger symbols 602 may not necessarily be COR symbols and may include any other suitable symbol types. The COR symbols are provided on one or more virtual reels stored in the memory. The reel strips include a plurality of additional symbols (not shown in FIGS. 5-9).

In some embodiments, the metamorphic associations (e.g., the color of the trigger symbols 602) are dynamically determined based on a random lookup performed prior to initiating a spin. For example, the trigger symbols 602 may be stored in fixed symbol positions on the reel strips and, for each trigger symbol 602 and prior to initiating the first spin, a random determination is made for each of the trigger symbols 602 to determine which color is assigned to each trigger symbol 602. In one embodiment, the random determination is made by performing a lookup of a weighted table using an RNG output. In some such embodiments, the weighted table includes entries for each of the available metamorphic associations (e.g., red, blue, and green), and optionally entries for multi-color symbols that include two or more metamorphic associations.

Referring to FIG. 4, a fifth step 410 of process 400 includes determining, in response to metamorphic trigger symbols occurring in the outcome of the base game, whether to award a feature enhancement associated with at least one of the metamorphic indicator and the plurality of sub-metamorphic indicators.

Referring back to FIG. 6, the determination is made with respect to each metamorphic trigger symbol 602 occurring in the outcome. For each trigger symbol 602, a lookup of one or more weighted tables is performed using one or more outcomes of a random number generator (“RNG”) to determine whether to award any feature enhancements and which feature enhancements to award.

In one example, a single RNG output is generated for each trigger symbol 602 and three weighted tables are stored in the memory, corresponding to the three metamorphic indicators 516. Lookups are performed of each weighted table corresponding to the metamorphic indicator 516 and/or sub-metamorphic indicators 514 associated with the trigger symbols 602 occurring in the outcome. The weighted tables may include a column identifying one or more of the available feature enhancements associated with the respective metamorphic indicator 516 and sub-metamorphic indicators 514. As an example, in response to the first trigger symbol 604 occurring in the outcome, a lookup of a first weighted table is performed using a first RNG output. The first weighted table includes entries indicating that “add one row” feature enhancement (“F1”) is triggered, that the “add two rows” feature enhancement (“F2”) is triggered, that both feature enhancements (“F1” and “F2”) are triggered if “F1” is not a subset of “F2” (that may add 3 additional rows), or that neither of the feature enhancements associated with the first metamorphic indicator 518 are triggered.

In another embodiment, different weighted tables are used for the lookups based on the number and/or types of trigger symbols 602 occurring in the outcome. In some such embodiments, each combination of triggering symbols 602 occurring in the outcome includes a corresponding weighted table or set of weighted tables that are used to determine whether a feature enhancement is triggered. For example, a first set of weighted tables may be used for the lookups based on trigger symbols 604, 606 where the third trigger symbol 608 occurs in the outcome and a second set of weighted tables may be used for the lookups for the trigger symbols 604, 606 where no third trigger symbol 608 is present in the outcome. The second set of weighted tables may include one or more different weighted tables from the first set resulting in different outcomes from lookups based on at least one of the trigger symbols 604, 606.

In other embodiments, more than one lookup may be performed in response to each corresponding trigger symbol 602 occurring in the base game outcome to determine whether any of the feature enhancements are triggered. As an example, in one embodiment, a first lookup of a first weighted table is performed to determine whether any one the feature enhancements associated with the first metamorphic indicator 518 should be awarded. If it is determined, based on the first lookup, that one of the feature enhancements is triggered, a second lookup of a second weighted table is performed (e.g., using either the same or an additional RNG output) to determine which of the available feature enhancements (i.e., one or two additional rows) to award.

In the example symbol driven embodiment, after the base outcome is generated, the processor 204 determines the types of trigger symbols 602 that have occurred in the outcome and selects an associated one or more weighted tables based on the determination that are used to determine whether the metamorphic feature is triggered and, if so, the level (i.e., sub-metamorphic) that is triggered in response. For example, where only one color of a trigger symbol 602 occurs in the base outcome, a different weighted table may be used relative to an outcome including two or three trigger symbols 602. In some embodiments, the sets of weighted tables may be associated with specific color combinations of the trigger symbols 602. For example, if the outcome includes red and blue symbols, a different set of weighted tables may be selected for the lookup than an outcome that includes green and red symbols or green and blue symbols.

In the example symbol driven embodiment, in response to the trigger symbols 602 occurring in the outcome, a lookup of the one or more selected weighted tables is performed using one or more RNG outputs to determine whether the corresponding metamorphic feature is triggered and, if so, which level of the metamorphic feature is triggered. In the example embodiment, a lookup of a first weighted table using a first RNG output is performed to determine whether the metamorphic feature is triggered. If the feature is triggered based on the lookup, a lookup of a second weighted table using a second RNG output is performed to determine which level of the feature is triggered. In other embodiments in which the game outcome is randomly driven, the determination of whether to trigger the metamorphic feature and/or sub-metamorphic features may be separate and independent from the RNG output used to generate the game outcome. In some such embodiments, one or more RNG outputs may be used to determine whether any of the metamorphic features are triggered and, if so, a game outcome is generated in response that includes the corresponding trigger symbol associated with the triggered metamorphic feature.

Referring to FIG. 6, in the example embodiment, the lookups are performed for each trigger symbol 602 occurring in the base game outcome. Where a trigger symbol 602 does not result in an awarded feature enhancement, a visual incrementing effect may be provided to the associated metamorphic indicator 516 and/or sub-metamorphic indicators 514. In the example embodiment, the visual incrementing effect 540, shown in FIG. 5, includes illuminating one or more of the firecrackers along the length of the firecracker strand for the corresponding indicator. In some embodiments, a visual incrementing effect may also be provided to one or more of the sub-metamorphic indicators 514, such as by changing a size, shape, position, effect, and/or color of the sub-metamorphic indicator 514. For example, in some embodiments, in response to determining that no feature enhancement is awarded from the first trigger symbol 604, a size of the first sub-metamorphic indicator 530 and second sub-metamorphic indicator 532 may be increased.

In some embodiments, the metamorphic trigger symbols 602 may include symbols that trigger a lookup to determine whether to award a feature enhancement for a specified one of sub-metamorphic indicator and/or a multi-triggering symbol (not shown). The multi-triggering symbol may be associated with more than one of the metamorphic indicators 516 and/or sub-metamorphic indicators 514 and trigger multiple lookups.

In the example embodiment, the multi-triggering symbol includes a plurality of visual indicators identifying more than one of the metamorphic indicators 516. For example, in one embodiment, one or more of the trigger symbols may be assigned as a multi-triggering symbol and displayed having two or more of the colors associated with the metamorphic indicators 516. As an example, in the example embodiment, the multi-triggering symbol may be displayed as having red, blue, and green sections indicating that the symbol is a trigger for each of the metamorphic indicators 516. In some such embodiments, the multi-triggering symbol is evaluated as including each of its corresponding displayed indicators for selecting the weighted tables used to determine whether the features are triggered. For example, the same weighted tables may be selected for a base game outcome that includes both a blue trigger symbol and a red trigger symbol as an outcome that includes a single blue and red multi-triggering symbol.

In some embodiments, the multi-triggering symbol may include a plurality of visual indicators identifying more than one of the sub-metamorphic indicators 514. For example, in one embodiment, the first metamorphic indicator has a middle green color, the first sub-metamorphic indicator 530 has a light green color, and the second sub-metamorphic indicator 532 has a dark green color. The metamorphic trigger symbols 602 may include middle green firecracker symbols, indicating triggering of the first metamorphic indicator 518, light green firecracker symbols indicating triggering of the first sub-metamorphic indicator 530, dark green firecracker symbols indicating triggering of the second sub-metamorphic indicator 532, and/or a multi-triggering symbol including both a light green firecracker and a dark green firecracker in a single symbol. In some such embodiments, in response to the multi-triggering symbol occurring in the outcome a first lookup is performed using a first RNG output to determine whether to award the first feature enhancement associated with the first sub-metamorphic indicator 530 and a second lookup is performed using a second RNG output to determine whether to award the second feature enhancement associated with the second sub-metamorphic indicator 532.

Referring to FIG. 4, a sixth step 412 in process 400 includes displaying, in response to awarding the feature enhancement, a visual activation effect to the at least one of the metamorphic indicator and the plurality of sub-metamorphic indicators.

Referring to the example of FIG. 6, it is determined that that feature enhancements associated with each one of the first through third metamorphic indicators 516 are activated. In response, a visual activation effect 601 is displayed to each of the metamorphic indicators 516. In the example of FIG. 6, the visual activation effect 601 includes an animation, shown by the arrows 610, of an element from metamorphic triggering symbols 602 launching to the corresponding metamorphic indicator 516 and igniting the full strand of firecrackers. In some embodiments, the animation 610 is also shown when the visual incrementing effect 540 (shown in FIG. 5) is applied.

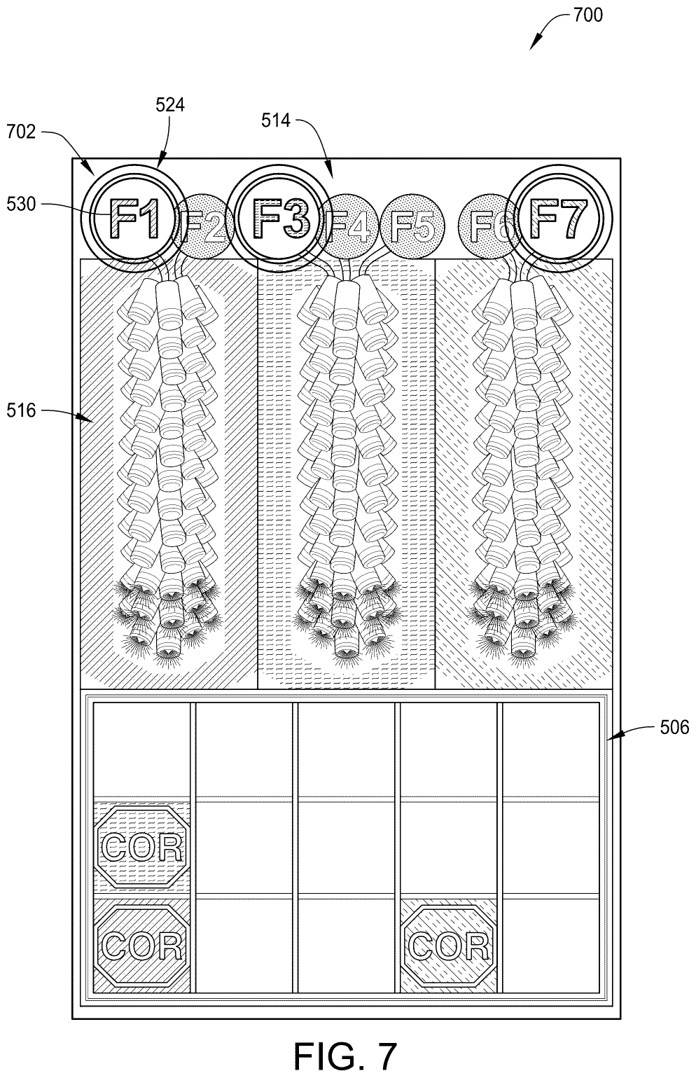

FIG. 7 shows a display 700 of the first game instance subsequent to the display 600, shown in FIG. 6. Referring to FIG. 7, a visual activation effect 702 is further applied to each of the sub-metamorphic indicators 514 that are associated with each of the corresponding awarded feature enhancements. The visual activation effect 702 applied to the sub-metamorphic indicators 514 includes a temporary enlargement, filling in with color, and adding outlines to the activated sub-metamorphic indicators 514. In the example, the visual activation effect applied to the first sub-metamorphic indicator 530 of the first group 524 indicates that the “one additional row” feature enhancement is awarded and the lack of a visual activation effect to the second sub-metamorphic indicator 532 of the first group 524 indicates that the “two additional row” feature enhancement is not awarded.

In the example embodiment, each awardable feature enhancement is associated with one of sub-metamorphic indicators 514, such that the visual activation effect 702 is applied to one of the sub-metamorphic indicators 514 for each awarded feature enhancement. In some embodiments, awarding of feature enhancements may be displayed by the visual activation effect 601 (shown in FIG. 6) to one of the metamorphic indicators 516, with or without the visual activation 702 effect being applied to the associated sub-metamorphic indicators 514. As an example, in one embodiment, awarding of the “one additional row” feature enhancement is displayed by lighting all firecrackers of the first metamorphic indicator 518 and the visual activation effect is applied to sub-metamorphic indicators 514 to only if further additional rows are awarded.

In the example embodiment, at least some of feature enhancements have a nested hierarchical value, such that higher order feature enhancements of a group necessarily include the value of lower order feature enhancements. In some such embodiments, when a higher order feature enhancement is awarded, the visual effect may be applied to both the associated sub-metamorphic indicator 514 and any other sub-metamorphic indicators 514 of the same group associated with lower order hierarchical feature enhancements. For example, in the example embodiment, the “two additional rows” feature enhancement includes within it the lower order feature enhancement of “one additional row”, in that, if both are awarded, only two additional rows would be added to the matrix 506. In some such embodiments, the visual activating effect 702 may be applied to both the first sub-metamorphic indicator 530 and the second sub-metamorphic indicator 532, in response to awarding the “two additional rows” feature enhancement.

In some embodiments, the feature enhancements of one or more of the groups 524, 526, 528 are compounded, such that the awarding of multiple feature enhancements of the same group provides a greater feature enhancement than awarding any single feature enhancement independently. As an example, in some embodiments, awarding the “one additional row” feature enhancement may add one row to the matrix 506, awarding the “two additional rows” feature enhancement may add two additional rows to the matrix 506, and awarding both the “one additional row” and the “two additional rows” feature enhancement may add three rows to the matrix 506. In such embodiments, the visual effect may only be applied to each sub-metamorphic indicator 514 in response to a determination that the associated feature enhancement is awarded.

In the example embodiment, the metamorphic indicators 516 are each reset to an initial state after a feature enhancement associated with the metamorphic indicator 516 is awarded. For example, as shown in FIG. 7, the firecracker strands are each reset and only the bottom firecrackers remain illuminated in the initial state. In other embodiments, no firecrackers are illuminated when the firecracker strands are in the initial state.

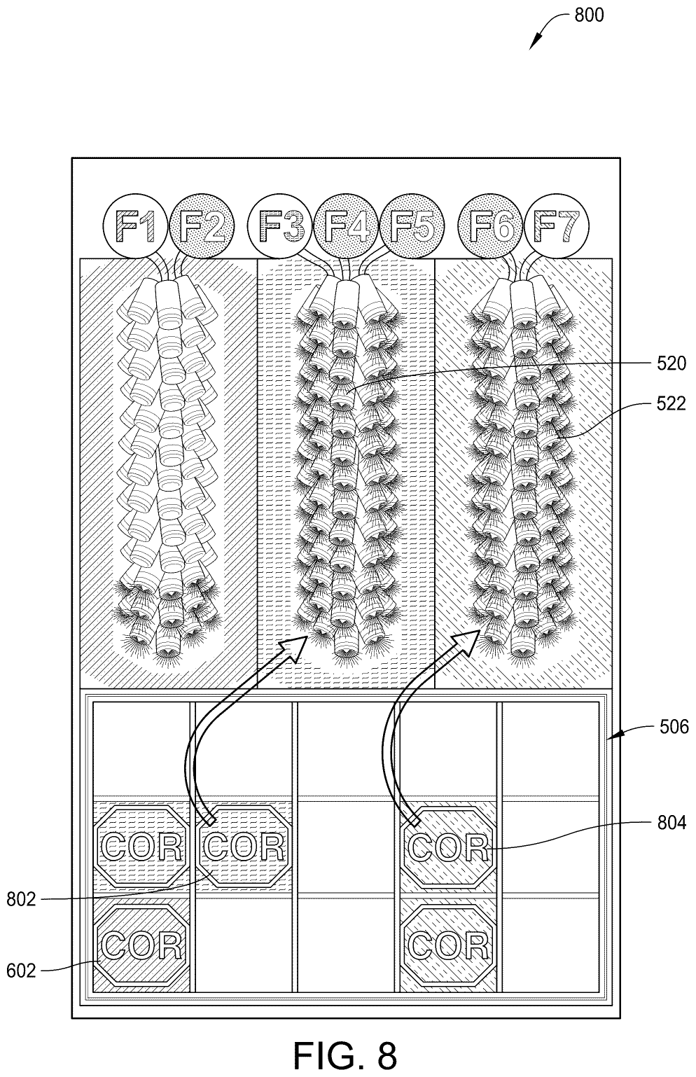

FIG. 8 shows a display 800 of second game play instance of base game subsequent to the first play instance, shown in FIGS. 5-7. Referring to FIG. 8, new metamorphic trigger symbols 802, 804 occur in game outcome. A first metamorphic trigger symbol 802 corresponds to the second metamorphic indicator 520 and a second metamorphic trigger symbol 804 corresponds to the third metamorphic indicator 522. In the example embodiment, the previously awarded metamorphic trigger symbols 602 are “sticky symbols” in that they persist in the matrix 506 for at least one or more play instances. In other embodiments, the matrix 506 is fully repopulated with new symbols between game play instances.

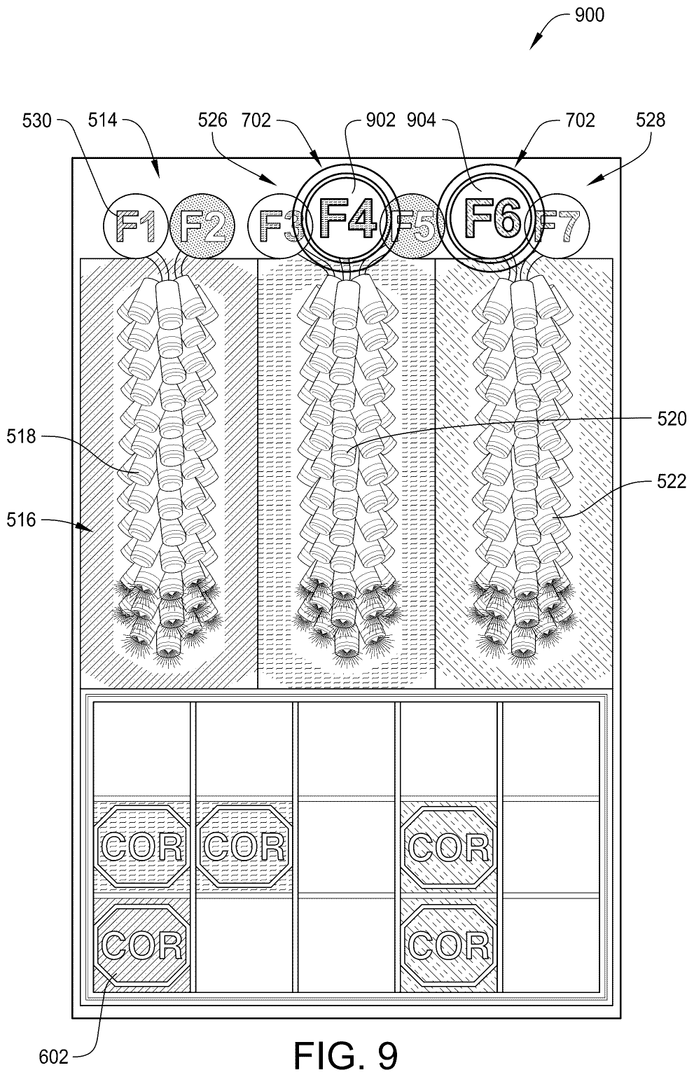

FIG. 9 shows display 900 of the second game play instance subsequent to display 800, shown in FIG. 8. As shown in FIG. 9, the visual activating effect 702 is applied to a second sub-metamorphic indicator 902 of the second group 526 and to a first sub-metamorphic indicator 904 of the third group 528. Additionally, the second and third metamorphic indicators 520, 522 are each reset to the initial state.

In the example embodiment, feature enhancements are collected during the base game and applied during play of a feature game. In some embodiments, one or more of feature enhancements may be applied during play of the base game, in response to the feature enhancement being awarded or based on a subsequent activation condition. For example, in one embodiment, the “one additional row” feature enhancement is applied during play of the base game on a next spin after the feature enhancement is awarded.

In some embodiments, collection of one or more of feature enhancements may trigger a bonus feature game. For example, in one embodiment the first metamorphic indicator 518 is associated with a “free plays” feature game and awarding the enhancement associated with the first sub-metamorphic indicator 530 triggers play of the “free plays” feature game. In some such embodiments, awarding of the enhancement associated with the second sub-metamorphic indicator 532 provides an enhancement to play of the “free plays” feature game, such as increased number of spins, a multiplier, increased matrix size, etc. In some embodiments, metamorphic trigger symbols 602 may occur during play of the “free plays” feature game, such that one or more feature enhancements may be awarded and applied during play of the “free plays” feature game.

In the example embodiment, upon triggering the feature game, each of the awarded feature enhancements are collectively applied during play of the feature game. In other embodiments, the feature enhancements are applied independently and sequentially. For example, in embodiments where the first enhancement includes a triggering a play of a first feature game (e.g., the “free plays” feature game), a second feature enhancement associated with the second metamorphic indicator 516 may trigger a different second feature game, such as a “match three” or “pick and pop” feature game. In some such embodiments, where both feature enhancements are awarded, play of the first feature game may first be performed and play of the second feature game may be performed after play of the first feature game is ended. After the feature enhancements are applied, the sub-metamorphic indicators 514 are reset to their initial state (e.g., greyed out in the example embodiment).

FIGS. 10-12 show game instances of an alternative game executed according to the process 400, which may be displayed on the main display 240 (shown in FIG. 2A). FIG. 10 shows a schematic of an example game display 1000 showing a first instance of the game display, prior to a first spin being initiated. The game shown in FIGS. 10-12 is substantially the same as the game shown in FIGS. 5-9 except as otherwise described differently herein.

Referring to FIG. 10, the game includes metamorphic indicators 1016 that are each associated with sub-metamorphic indicators 1014 that are displayed on the metamorphic indicators 1016. The sub-metamorphic indicators 1014 are each positioned in a hierarchal order along the respective metamorphic indicators 1016, such that a higher award feature sub-metamorphic indicator 1014, designated by the indicator “SUPREME” is positioned vertically above lower award feature sub-metamorphic indicators 1016. In the black and white FIGS. 10-12, the color labels 1001 indicate a color associated with the corresponding metamorphic indicators 1016. It should be understood that the color labels are shown in FIGS. 10-12 solely for the purpose of conveying the differences in color of the different metamorphic indicators 1016 and would not ordinarily be displayed during gameplay.

In the example embodiment, the metamorphic indicators 1016 include four metamorphic indicators, including a first metamorphic indicator 1018, a second metamorphic indicator 1020, a third metamorphic indicator 1022, and a fourth metamorphic indicator 1023. Each of the metamorphic indicators 1016 are associated with a different feature enhancement type that is indicated by the sub-metamorphic indicators 1014. For example, the first metamorphic indicator 1018 is associated with a “SPLIT” feature enhancement, the second metamorphic indicator 1020 is associated with a “ZONE” feature enhancement, the third metamorphic indicator 1022 is associated with a “ROWS” feature enhancement, and the fourth metamorphic indicator 1023 is associated with an “EXTRA” feature enhancement.

The sub-metamorphic indicators 1014 include two sub-metamorphic indicators 1014 displayed in visual association (e.g., by being positioned on) with the metamorphic indicators 1016 and each having a reduced size relative to the respective metamorphic indicators 1014. For example, the first sub-metamorphic indicator 1018 includes a first sub-metamorphic indicator 1030 and a second sub-metamorphic indicator 1032. The second sub-metamorphic indicator 1020 includes a first sub-metamorphic indicator 1034 and a second sub-metamorphic indicator 1036. The third sub-metamorphic indicator 1022 includes a first sub-metamorphic indicator 1038 and a second sub-metamorphic indicator 1040. The fourth sub-metamorphic indicator 1024 includes a first sub-metamorphic indicator 1042 and a second sub-metamorphic indicator 1044.

In the example embodiment, each of the feature enhancements associated with the sub-metamorphic indicators 1014 may be awarded individually and/or in combination with the feature enhancements of any one of the other sub-metamorphic indicators 1014. For example, in the example embodiment, for each of the metamorphic indicators 1016, in response to any game instance, the first lower order feature enhancement of the first sub-metamorphic indicators may be awarded, the second higher order feature enhancement of the second sub-metamorphic indicators may be awarded, or no feature enhancements may be awarded. As a result, for each metamorphic indicator 1014, there are three potential award outcomes. Moreover, each combination of the feature enhancements associated with each of the metamorphic indicator 1016 may be awarded in combination with any of the other potential feature enhancements of the other metamorphic indicators 1016. The number of potential award outcomes including all metamorphic indicators is equal to the number of potential award outcomes for the first metamorphic indicator 1018 (e.g., 3), multiplied by the potential award outcomes of the second metamorphic indicator 1020 (e.g., 3), multiplied by the potential award outcomes of the third metamorphic indicator 1022 (e.g., 3), multiplied by the potential award outcomes of the fourth metamorphic indicator 1024 (e.g., 3). In the example embodiment, there are 81 combination outcomes (e.g., 3*3*3*3) that may be awarded and displayed by the metamorphic indicators 1016 and sub-metamorphic indicators 1014. Since one of the 81 potential combinations includes a single outcome in which no feature enhancement is awarded, there are 80 potential combination outcomes in which a feature enhancement is awarded. As a result, the efficiency in use of the display area is improved as an increased number of potential outcomes may be displayed in the display area occupied by the metamorphic indicators 1016.

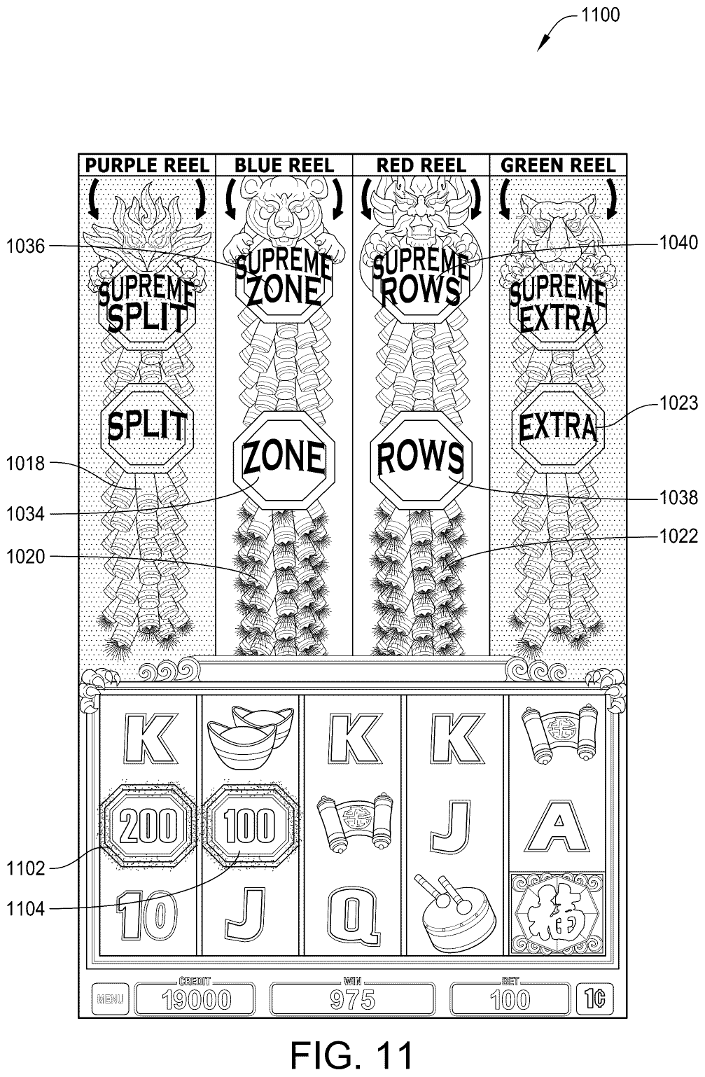

FIG. 11 shows the game instance of FIG. 10 after the initial spin. As shown in FIG. 11, two COR symbols 1102 and 1104 have occurred in the base game outcome. In the example embodiment, the COR symbol 1102 is colored blue and associated with the second metamorphic indicator 1020 and the COR symbol 1104 is colored red and associated with the third metamorphic indicator 1022. In the example embodiment, the COR symbols 1102 and 1104 in the outcome have resulted in triggering of the sub-metamorphic features 1034 and 1038 for the second and third metamorphics 1020, 1022, respectively, but have not triggered the “SUPREME” sub-metamorphics 1036 or 1040. As shown in FIG. 11, the first metamorphic indicator 1018 and the fourth metamorphic indicator 1023 are greyed out (shown in grey stippling in FIG. 11) while the other features are awarded.

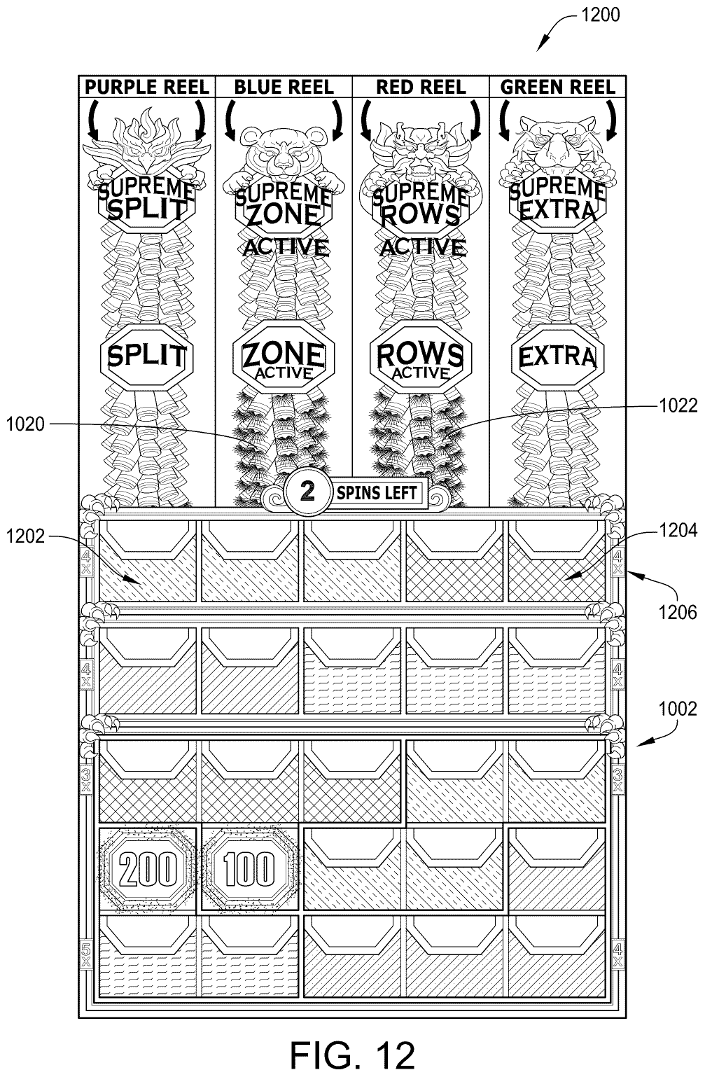

FIG. 12 shows a feature game instance following the game instance of FIG. 11, in which the “ZONE” and the “ROWS” features have been triggered. As shown in FIG. 12, the enhanced features include a change to the primary display area 1002 to include different colored zones 1202, 1204 (indicated by differently hatched symbol positions), added rows, and multipliers 1206 associated with the different color zones. Additionally, the second and third metamorphic indicators 1020 and 1022 are shown as active.

The game displays shown in FIGS. 5-9 and FIGS. 10-12 show non-limiting iterations of the game described herein. In other iterations, one or more different combinations of metamorphic and sub-metamorphic indicators may be applied.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming system comprising:
at least one processor; and
at least one memory storing instructions thereon wherein the instructions, when executed by the at least one processor, cause the at least one processor to:
cause display of a game outcome in a primary display area of at least one display;
cause display of a metamorphic indicator in a secondary display area of the at least one display;
cause display of a plurality of sub-metamorphic indicators in visual association with the metamorphic indicator in the secondary display area, the visual association linking the plurality of sub-metamorphic indicators with the metamorphic indicator, each sub-metamorphic indicator of the plurality of sub-metamorphic indicators having a reduced size on the at least one display relative to the metamorphic indicator and identifying a respective feature enhancement that is awardable based on a triggering of the metamorphic indicator;
identify a metamorphic trigger symbol occurring in the game outcome, the metamorphic trigger symbol being a trigger for the metamorphic indicator; and
determine, in response to identifying the metamorphic trigger symbol, whether to award a feature enhancement associated with at least one of the plurality of sub-metamorphic indicators.

2. The gaming system of claim 1, wherein the metamorphic indicator is a first metamorphic indicator of a plurality of metamorphic indicators displayed in the second display area and the metamorphic trigger symbol is a first metamorphic trigger symbol occurring in the game outcome, wherein the instructions further cause the at least one processor to:
assign a first metamorphic association to the first metamorphic trigger symbol, the first metamorphic association associating the first metamorphic trigger symbol with the first metamorphic indicator; and
assign a second metamorphic association to a second metamorphic trigger symbol, the second metamorphic association associating the second metamorphic trigger symbol with a second metamorphic indicator of the plurality of metamorphic indicators.

3. The gaming system of claim 2, wherein determining whether to award a feature enhancement is based on the first metamorphic association assigned to the first metamorphic trigger symbol, and wherein the instructions further cause the at least one processor to:
identify the second metamorphic trigger symbol occurring in the game outcome; and
determine, based on the second metamorphic trigger symbol occurring in the game outcome and the second metamorphic association being assigned to the second metamorphic trigger symbol, whether to award an additional feature enhancement associated with the second metamorphic indicator and the plurality of sub-metamorphic indicators.

4. The gaming system of claim 2, wherein assigning the first metamorphic association to the first metamorphic trigger symbol includes displaying the first metamorphic trigger symbol to have a first color, and wherein assigning the second metamorphic association to the second metamorphic trigger symbol includes displaying the second metamorphic trigger symbol to have a second color, wherein the first metamorphic indicator includes the first color and the second metamorphic indicator includes the second color.

5. The gaming system of claim 2, wherein determining the game outcome is performed after assigning the first metamorphic association and the second metamorphic association.

6. The gaming system of claim 2, wherein determining whether to award the feature enhancement comprises:
determining a total number of metamorphic associations occurring in the game outcome;
selecting a first set of one or more weighted lookup tables from a plurality of weighted lookup tables based on the determined number of metamorphic associations; and
performing a lookup of a first weighted table from the first set of one or more weighted lookup tables using a first output from a random number generator.

7. The gaming system of claim 6, wherein each of the sub-metamorphic indicators is associated with a different level of the feature enhancement, wherein determining whether to award the feature enhancement comprises:
performing a lookup of a second weighted table from the first set of one or more weighted lookup tables using a second output from a random number generator, wherein the lookup identifies a level of the feature enhancement to be awarded.

8. The gaming system of claim 1, wherein the visual association includes a positioning the plurality of sub-metamorphic indicators on or adjacent to the metamorphic indicator.

9. The gaming system of claim 1, wherein the instructions further cause the at least one processor to:
display, in response to awarding the feature enhancement, a visual activation effect to the at least one of the metamorphic indicator and the plurality of sub-metamorphic indicators.

10. The gaming system of claim 1, wherein the game is a base game and the feature enhancements associated with the sub-metamorphic indicators are applied during play of a bonus feature game.

11. The gaming system of claim 1, wherein the feature enhancements associated with the sub-metamorphic indicators are hierarchical feature enhancements and are displayed in hierarchical order.

12. The gaming system of claim 1, wherein the metamorphic indicator is a first metamorphic indicator of a plurality of metamorphic indicators displayed in the second display area, and wherein the plurality of sub-metamorphic indicators is a first plurality of sub-metamorphic indicators, wherein each metamorphic indicator of the plurality of metamorphic indicators is displayed in a visual association with a corresponding plurality of sub-metamorphic indicators.

13. The gaming system of claim 12, wherein the plurality of metamorphic indicators includes a second metamorphic indicator, and a third metamorphic indicator, the second metamorphic indicator being displayed in visual association with a second plurality of sub-metamorphic indicators, and the third metamorphic indicator being displayed in visual association with a third plurality of sub-metamorphic indicators, wherein the first plurality of sub-metamorphic indicators includes a different number of sub-metamorphic indicators from at least one of the second plurality of sub-metamorphic indicators and the third plurality of sub-metamorphic indicators.

14. A non-transitory computer-readable medium storing instructions thereon which, when executed by at least one processor, cause the at least one processor to:
cause display of a game outcome in a primary display area of a display, the game outcome including a metamorphic trigger symbol;
cause display of a metamorphic indicator in a secondary display area of the display, wherein the metamorphic trigger symbol is a trigger for the metamorphic indicator;
cause display of a plurality of sub-metamorphic indicators in the secondary display area, each sub-metamorphic indicator of the plurality of sub-metamorphic indicators being displayed in position adjacent to or along the metamorphic indicator, having a reduced size on the display relative to the metamorphic indicator, and identifying a respective feature enhancement that is awardable based on a triggering of the metamorphic indicator; and
determine, based on the game outcome including the metamorphic trigger symbol, whether to award a feature enhancement associated with at least one of the plurality of sub-metamorphic indicators.

15. The non-transitory computer-readable medium of claim 14, wherein the metamorphic indicator is a first metamorphic indicator of a plurality of metamorphic indicators displayed in the second display area and the metamorphic trigger symbol is a first metamorphic trigger symbol occurring in the game outcome, wherein the instructions further cause the at least one processor to:
assign a first metamorphic association to the first metamorphic trigger symbol, the first metamorphic association associating the first metamorphic trigger symbol with the first metamorphic indicator; and
assign a second metamorphic association to a second metamorphic trigger symbol, the second metamorphic association associating the second metamorphic trigger symbol with a second metamorphic indicator of the plurality of metamorphic indicators.

16. The non-transitory computer-readable medium of claim 15, wherein determining whether to award a feature enhancement is based on the first metamorphic association assigned to the first metamorphic trigger symbol, and wherein the instructions further cause the at least one processor to:
identify the second metamorphic trigger symbol occurring in the game outcome; and
determine, based on the second metamorphic trigger symbol occurring in the game outcome and the second metamorphic association being assigned to the second metamorphic trigger symbol, whether to award an additional feature enhancement associated with the second metamorphic indicator and the plurality of sub-metamorphic indicators.

17. The non-transitory computer-readable medium of claim 15, wherein assigning the first metamorphic association to the first metamorphic trigger symbol includes displaying the first metamorphic trigger symbol to have a first color, and wherein assigning the second metamorphic association to the second metamorphic trigger symbol includes displaying the second metamorphic trigger symbol to have a second color, wherein the first metamorphic indicator includes the first color and the second metamorphic indicator includes the second color.

18. A method of electronic gaming comprising:
displaying a game outcome in a primary display area of at least one display;
displaying a metamorphic indicator in a secondary display area of the at least one display;
displaying a plurality of sub-metamorphic indicators in visual association with the metamorphic indicator in the secondary display area, the visual association linking the plurality of sub-metamorphic indicators with the metamorphic indicator, each sub-metamorphic indicator of the plurality of sub-metamorphic indicators having a reduced size on the at least one display relative to the metamorphic indicator and identifying a respective feature enhancement that is awardable based on a triggering of the metamorphic indicator;
identifying, by at least one processor, a metamorphic trigger symbol occurring in the game outcome, the metamorphic trigger symbol being a trigger for the metamorphic indicator; and
determining, by the at least one processor, in response to identifying the metamorphic trigger symbol, whether to award a feature enhancement associated with at least one of the plurality of sub-metamorphic indicators.

19. The method of claim 18, wherein the metamorphic indicator is a first metamorphic indicator of a plurality of metamorphic indicators displayed in the second display area and the metamorphic trigger symbol is a first metamorphic trigger symbol occurring in the game outcome, the method further comprising:
assigning a first metamorphic association to the first metamorphic trigger symbol, the first metamorphic association associating the first metamorphic trigger symbol with the first metamorphic indicator; and
assigning a second metamorphic association to a second metamorphic trigger symbol, the second metamorphic association associating the second metamorphic trigger symbol with a second metamorphic indicator of the plurality of metamorphic indicators.

20. The method of claim 19, wherein determining whether to award a feature enhancement is based on the first metamorphic association assigned to the first metamorphic trigger symbol, and wherein the method further comprises:
identifying the second metamorphic trigger symbol occurring in the game outcome; and
determining, based on the second metamorphic trigger symbol occurring in the game outcome and the second metamorphic association being assigned to the second metamorphic trigger symbol, whether to award an additional feature enhancement associated with the second metamorphic indicator and the plurality of sub-metamorphic indicators.
